(19) United States
(12) Patent Application Publication
(10) Pub. No.: US 2024/0318857 A1
(43) Pub. Date: Sep. 26, 2024

(54) SENSOR AND SYSTEM

(71) Applicant: John Saffell, Cambridge (GB)

(72) Inventor: John Saffell, Cambridge (GB)

(21) Appl. No.: 18/610,883

(22) Filed: Mar. 20, 2024

(30) Foreign Application Priority Data
Mar. 20, 2023 (GB) 2304023.1

(51) Int. Cl. F24F 11/65; F24F 11/50; G01D 21/02; F24F 110/10; F24F 110/20; F24F 110/30; F24F 110/40; F24F 110/70

(52) U.S. Cl. CPC F24F 11/65; F24F 11/50; G01D 21/02; F24F 2110/10; F24F 2110/20; F24F 2110/30; F24F 2110/40; F24F 2110/70

(57) ABSTRACT

The present disclosure relates to a sensor and a system comprising a plurality of said sensors. An aspect of the disclosure provides, a device for obtaining indications for the study of thermal comfort of an environment within which the device is located, the device comprising: an pressure sensor configured to obtain an indication of pressure of the environment; a carbon dioxide sensor configured to obtain an indication of the amount of carbon dioxide in the environment; an ambient temperature sensor configured to obtain an indication of the ambient temperature of the environment; a relative humidity sensor configured to obtain an indication of the relative humidity of the environment; a radiant temperature sensor configured to obtain an indication of the radiant temperature in the environment; a first airspeed sensor configured to obtain an indication of air speed in a first direction; and,; a communication interface configured to send the indications to a computing device for determining an indication of the thermal comfort of the environment.

### CROSS REFERENCE TO RELATED APPLICATIONS

This application claims priority to and the benefit of GB Patent Application 2304023.1, filed 20 Mar. 2023, the entire disclosure of which is expressly incorporated by reference herein.

### FIELD OF DISCLOSURE

The present disclosure relates to a sensor and a system comprising a plurality of said sensors, in particular, an indoor air quality (IAQ) sensor and an indoor environment quality (IEQ) sensor.

### BACKGROUND

Networks of low cost sensors (LCS) are used to monitor the outdoor air quality in cities. These networks are used in some cities to provide maps showing the relative air quality in different locations of the city. However, people spend 90% of their time indoors, in the built environment.

National, regional and international regulations and guidelines define acceptable air quality by establishing Limit Values for gases and particles. Many of these Limit Values are regulations and cities must monitor their outdoor air to ensure compliance. This information is important for politicians, traffic controllers, city planners, construction project managers and commuters. However, most of our exposure occurs inside, where the air quality, although also depending on the outdoor air, is different than the outdoor air quality.

Indoor air is not as regulated because the composition of the air is more complex and there are so many types of indoor spaces such as bedrooms, kitchens, offices, classrooms, hospital wards, gyms, concert halls, swimming pools, restaurants and shops. In addition, buildings are in different states of repair and their ventilation systems vary from computer controlled building management systems to half-open windows.

Hundreds of studies have been undertaken to study indoor air quality (IAQ) but the conclusions and recommendations are not consistent. In addition, air quality is only one of three goals when designing or upgrading a space in the built environment. The second goal is energy efficiency: the built environment consumes approximately 40% of the total global energy, thus ventilation systems must operate at the lowest energy usage to reduce global warming. The third goal is thermal comfort which includes temperature, relative humidity, local drafts and noise and light levels. All three of these goals are important and finding the best compromise for all three goals is a challenge.

There are devices that monitor each of these three with some cross-over, but current measuring devices do not holistically measure all three (air quality, thermal comfort and energy efficiency) hence are missing critical parameters when monitoring the built environment.

There are guidelines and standards for all three conditions.

Thermal comfort has been studied for many years, measuring our discomfort due to hot rooms, drafts, clothing and radiant heat. ANSI/ASHRAE 55:2020 is the latest edition of Thermal Environmental Conditions for Human Occupancy, first published in 1966. ISO 7730 is a parallel standard for thermal comfort.

There are many standards and guidelines for ventilation control, including design, maintenance, balancing, filtration and importantly, human requirements for fresh air, frequently using CO2 as a tracer gas. Indoor Air Quality (IAQ) is the subject of a host of standards covering gases, IAQ audits, IAQ surveys, particles, VOCs and testing of construction materials and soft fabrics. They provide test procedures and guidelines for best practice, and consider ventilation where possible, but they do not integrate with thermal comfort. The most frequently consulted document is the World Health Organisation WHO Guidelines for Indoor Air: 2010.

This diverse set of standards and guidelines has led instrumentation manufacturers to focus on one of the three goals, but not try to integrate across the boundaries of these different standards.

There are many air quality monitors available to purchase which typically measure temperature, relative humidity and carbon dioxide (CO2). From the CO2 concentration they estimate the air quality. This simple assumption has drawbacks: the data quality from many CO2 sensors is poor and often the user only sees the instantaneous reading or the readings are updated infrequently, missing critical transient information.

Interpreting air quality from CO2 concentration requires knowledge of many parameters (see e.g. as explained in ASHRAE 62 and ASTM D6245). CO2 is generated by human breathing in the space, so the number of people, their demographics and level of activity all contribute to the amount of CO2 injected in the room, a concentration of injected gas that is not easily quantified. Likewise, without knowing the room volume, using CO2 as a tracer gas is not sensible.

Some devices provide further measurements including the important pollutant gases, nitrogen dioxide (NO2), ozone (03) and carbon monoxide (CO). Particles are also monitored in some devices, since they have been shown to also be toxic. Discounting the very low cost CO2 monitors, there are devices that can measure the air quality, specifically gases and particles. Some devices claim to measure volatile organic compounds (VOCs) but in reality they are making a broadband measurement using either metal oxide sensors or the more accurate and more sensitive photoionization detectors (PIDs). The current state is that there are air quality monitors that measure gases and particles with different data qualities and some measure noise and light, although they do not process that information or integrate it with the air quality data. The goal when constructing or refurbishing a built space should be to select low emitting construction and soft materials and provide adequate ventilation to flush out pollutants and hopefully filter out particles and scrub gases and VOCs. But this is to be achieved at the minimum energy from the ventilation system.

Thermal comfort is an easier measurement, frequently measuring just the ambient temperature and relative humidity. However, to correctly assess thermal comfort (ASHRAE 55 and ISO 7730), air movement and radiant heat must also be measured and activity level and clothing must be defined. There is currently no low cost device that measures the four parameters, and analysis would require the user entering clothing and the activity level of the occupants to quantify correctly the thermal comfort: the goal is to ensure a comfortable environment but with minimum heat/cool and ventilation energy.

Ventilation systems are critical for indoor air comfort and air quality. Mechanical systems can be simple or complex and natural ventilation depends on opening windows along with natural infiltration from air leakage between rooms or from the outdoor environment. Ventilation systems can be quantified by recording volumetric airflow using airspeed sensors in the ventilation duct, but this does not reflect the local drafts that people experience: airflow is typically turbulent and vent locations, windows, doors, furniture all influence the local airflow over the person's skin and clothing. This measurement is not included in fixed network devices that monitor thermal comfort.

In some circumstances (e.g. indoors) a chemical in the air may have adverse health consequences for nearby people, for example if the chemical is present in quantities at or above a given threshold. Some typical devices (such as those described in U.S. Pat. No. 9,729,945B2) comprise a sensor and an alarm, arranged so that if a measured chemical in an environment exceeds a given threshold, the alarm is sounded to alert people near the sensor.

Some typical devices (such as those described in US2022/0099521A1, U.S. Pat. No. 11,338,107B2 & U.S. Pat. No. 11,226,128B2) comprise a plurality of sensors for measuring changes in an environment within which the device is disposed.

Typical devices comprising sensors (such as those described in US2021/0231338A1) comprise a means of calibrating the sensors disposed therein, for example, setting an initial offset correction to measurements made by the sensors and/or setting a long term drift correction to measurements made by the sensors.

### SUMMARY

The present invention is defined by the appended independent claims. Optional features are set out in the dependent claims.

An aspect provides a device for obtaining indications for the study of thermal comfort of an environment within which the device is located, the device comprising: a pressure sensor configured to obtain an indication of pressure of the environment; a carbon dioxide sensor configured to obtain an indication of the amount of carbon dioxide in the environment; an ambient temperature sensor configured to obtain an indication of the ambient temperature of the environment; a relative humidity sensor configured to obtain an indication of the relative humidity of the environment; a radiant temperature sensor configured to obtain an indication of the radiant temperature in the environment; a first airspeed sensor configured to obtain an indication of air speed in a first direction; and, a communication interface configured to send the indications to a computing device for determining an indication of the thermal comfort of the environment. Advantageously a single device is provided for studying thermal comfort in a given location.

The device may comprise one or more gas sensors configured to obtain an indication of concentrations of pollutant gases in the environment. The pollutant gases may be any of: carbon monoxide, nitric acid, nitrogen dioxide, ozone, sulfur dioxide, ammonia, and hydrogen sulfide.

The device may comprise a second airspeed sensor configured to obtain an indication of air speed in a second direction, wherein the second direction is oblique or perpendicular to the first direction.

The device may comprise a housing having: an exterior surface; an interior surface inclosing an interior of the housing; and, at least one aperture configured to permit fluid communication between the environment and the interior of the housing; wherein at least the ambient temperature sensor is disposed within the interior of the housing.

Providing an aperture may permit cooling of the passive cooling of components disposed within the interior of the housing. Advantageously, this may extirpate the need for active cooling of the components (e.g. using air movers such as fans) which also generate heat and may save power consumption of the device because there are no active cooling components to power.

Each of the sensors may comprise: a first mode wherein the sensor obtains absolute indications indicative of an absolute value of a parameter of the environment; and, a second mode wherein the sensor obtains indications indicative of changes in the parameter of the environment for a predetermined period of time; the device further comprising: a triggering sensor configured to obtain an indication of a change in a trigger parameter of the environment; wherein, in the event that the triggering sensor obtains an indication of a change in the trigger parameter of the environment above a predetermined threshold, the device triggers each of the other sensors, to switch from the first mode to the second mode.

The triggering sensor(s) may be a pressure sensor wherein the pressure sensor is configured to obtain an indication of barometric pressure in the environment, wherein in the event the indication indicates a change in the barometric pressure above a predetermined threshold the device triggers the other sensors to switch from the first mode to the second mode.

The device may comprise a radiant temperature sensor disposed at an exterior of the housing, wherein the radiant temperature sensor is configured to obtain an indication of the radiant temperature in the environment. The device may comprise a thermal absorbing layer thermally coupled to the radiant temperature sensor, wherein the thermal absorbing layer is configured to absorb radiative energy in the environment and wherein the radiant temperature sensor obtains an indication of the radiant temperature in the environment by obtaining an indication of the temperature of the thermal absorbing layer.

In examples, the thermal absorbing layer may be dispensed with e.g. so that a radiant temperature sensor may be provided without a thermal absorbing layer thermally coupled thereto. In such examples, indications of radiant temperature in the environment obtained by the radiant temperature sensor may be adjusted (e.g. by software run on a processor of the device or by software run on a processor of a system, wherein said system comprises the device) by a using a calibration constant which accounts for the emissivity of the radiant temperature sensor.

The device may comprise a noise sensor configured to obtain an indication of an amount of noise in the environment, wherein the indication is at least one of: A-weighted; C-weighted; and, Z-weighted.

An aspect provides a system comprising: a first device for obtaining indications for the study of thermal comfort of an environment within which the first device is located, the first device comprising: an pressure sensor configured to obtain an indication of pressure of the environment; a carbon dioxide sensor configured to obtain an indication of the amount of carbon dioxide in the environment; an ambient temperature sensor configured to obtain an indication of the ambient temperature of the environment; a relative humidity sensor configured to obtain an indication of the relative humidity of the environment; a radiant temperature sensor configured to obtain an indication of the radiant temperature in the environment; a first airspeed sensor configured to obtain an indication of air speed in a first direction; and, a second airspeed sensor configured to obtain an indication of air speed in a second direction, wherein the second direction is oblique or perpendicular to the first direction; a communication interface configured to send the indications to a computing device for determining an indication of the thermal comfort of the environment; and, a second device for obtaining indications for the study of thermal comfort of an environment within which the second device is located, wherein the second device comprises the same features as the first device; and, a processor configured: to receive the indications from the first device and the second device; to determine, based on the indications, an indication of the thermal comfort of the environment. Advantageously a system is provided for determining an indication of thermal comfort in an environment.

The processor may be configured to determine, based on the indications, at least one of: an indication of the air quality of the environment; an indication of the energy efficiency of the environment; an indication of air infiltration into the environment; an indication of performance of a mechanical ventilation system for ventilating the environment.

The indication of pressure from the first device may be modified to a modified indication of pressure based on at least one of: the indication of the amount of carbon dioxide from the first device; the indication of ambient temperature from the first device; and, the indication of relative humidity from the first device; and, the indication of pressure from the second device may be modified to a modified indication of pressure based on at least one of: the indication of the amount of carbon dioxide from the second device; the indication of ambient temperature from the second device; and, the indication of relative humidity from the second device.

The first device may comprise the processor; or, the second device may comprise the processor. Alternatively, the processor may be separate from the first device and second device. For example, the processor may be part of a cloud computer or a personal computer (e.g. a desktop, laptop, tablet or smartphone).

An aspect provides a method for determining an indication of thermal comfort of an environment using any suitable device described herein, the method comprising: obtaining an indication of pressure of the environment using the device; obtaining an indication of the amount of carbon dioxide in the environment using the device; obtaining an indication of the ambient temperature of the environment using the device; obtaining an indication of the relative humidity of the environment using the device; obtaining an indication of the radiant temperature in the environment using the device; obtaining an indication of air speed in a first direction using the device; and, obtaining an indication of air speed in a second direction using the device, wherein the second direction is oblique or perpendicular to the first direction; determining the indication of thermal comfort of the environment based on the indications. Advantageously a method is provided for determining an indication of thermal comfort in an environment.

The method may comprise: obtaining an indication of a concentration of a gas in the environment using the device; and/or, obtaining an indication of concentration of particles in the environment using the device; and/or obtaining an indication of a distribution of particle size of particles in the environment using the device.

In examples, the method for determining an indication of thermal comfort of an environment using a device provided herein may omit the step of obtaining an indication of pressure of the environment using the device. In such examples, the device(s) may not comprise a pressure sensor for obtaining an indication of the pressure of the environment.

An aspect provides a device for obtaining indications for studying transient behaviour of parameters of the environment within which the device is located, the device comprising: a pressure sensor configured to obtain an indication of pressure of the environment; a carbon dioxide sensor configured to obtain an indication of the amount of carbon dioxide in the environment; an ambient temperature sensor configured to obtain an indication of the ambient temperature of the environment; a relative humidity sensor configured to obtain an indication of the relative humidity of the environment; wherein each of the sensors comprises: a first mode wherein the sensor obtains absolute indications indicative of an absolute value of a parameter of the environment; and, a second mode wherein the sensor obtains indications indicative of changes in the parameter of the environment for a predetermined period of time; the device further comprising: a triggering sensor configured to obtain an indication of a change in a trigger parameter of the environment; wherein, in the event that the triggering sensor obtains an indication of a change in the trigger parameter of the environment above a predetermined threshold, the device triggers each of the pressure sensor, carbon dioxide sensor, ambient temperature sensor and relative humidity sensor to switch from the first mode to the second mode; and, a communication interface configured to send the indications to a computing device for studying transient behaviour of parameters of the environment. Advantageously a single device is provided for studying transient behaviour of parameters of environment.

The sampling rate of the first mode may be obtaining one indication any of: every 15 minutes; every 30 minutes; every 45 minutes; or every 60 minutes. The sampling rate of the second mode may be obtaining one indication any of: every 30 seconds; every 1 minute; or every 5 minutes.

In examples, the device may comprise any combination of: a nitrogen dioxide sensor, a gas sensor (e.g. a sensor for hydrogen sulfide or any other gas described herein etc.), and, a particle sensor (i.e. a particulate matter sensor),

The triggering sensor may be a light sensor, wherein the light sensor is disposed at an exterior of the housing, wherein the light sensor is configured to obtain an indication of light incident on the light sensor, wherein in the event the indication indicates an amount of light incident on the light sensor is above a predetermined light threshold the device triggers the other sensors to switch from the first mode to the second mode.

The triggering sensor may be a light sensor, wherein the light sensor is disposed at an interior of the housing, wherein the housing comprises an aperture to permit light to enter the interior of the housing, wherein the light sensor is configured to obtain an indication of light incident on the light sensor, wherein in the event the indication indicates an amount of light incident on the light sensor is above a predetermined light threshold the device triggers the other sensors to switch from the first mode to the second mode.

The triggering sensor may be a noise sensor, wherein the noise sensor is configured to obtain an indication of noise in the environment, wherein in the event the indication indicates an amount of noise in the environment is above a predetermined noise threshold the device triggers the other sensors to switch from the first mode to the second mode.

The device may comprise: a radiant temperature sensor configured to obtain an indication of the radiant temperature in the environment; a first airspeed sensor configured to obtain an indication of air speed in a first direction; and, a second airspeed sensor configured to obtain an indication of air speed in a second direction, wherein the second direction is oblique or perpendicular to the first direction; a communication interface configured to send the indications to a computing device for determining an indication of the thermal comfort of the environment.

The devices herein may comprise one of or any combination of: a nitrogen dioxide sensor configured to obtain an indication of an amount of nitrogen dioxide in the environment; a nitric oxide sensor configured to obtain an indication of an amount of nitric oxide in the environment; a hydrogen sulfide sensor configured to obtain an indication of an amount of hydrogen sulfide in the environment; a sulfur dioxide sensor configured to obtain an indication of an amount of sulfur dioxide in the environment; an ammonia sensor configured to obtain an indication of an amount of ammonia in the environment; a formaldehyde sensor configured to obtain an indication of an amount of formaldehyde in the environment; a benzene sensor configured to obtain an indication of an amount of benzene in the environment; an ozone sensor configured to obtain an indication of an amount of ozone in the environment; a carbon monoxide sensor configured to obtain an indication of an amount of carbon monoxide in the environment; a volatile organic compound sensor configured to obtain an indication of an amount of at least one volatile organic compound in the environment; and, a particulate matter sensor configured to obtain an indication of particulate matter in the environment. For example, each of these sensors may provide an indication the amount of that given chemical in the air in the environment, for example, an indication of the concentration of that given chemical in the air in the environment (e.g. in parts per million or any other appropriate indication of the amount of concentration of that given chemical). Any of the sensors described herein may a first mode and a second mode. The sensors provided herein may be connected to a multiplexer.

The particulate matter sensor may be configured to obtain an indication of particulate matter in the environment, for example, the indication may be an indication of concentration of particles in the environment, and/or an indication of a distribution of particle size of particles in the environment.

There may be provided gas sensors (e.g. those described above, the nitrogen dioxide sensor etc.) configured to obtain an indication of an amount of a given gas in the environment. The indication may be an indication of a concentration of the given gas in the environment.

Prior art sensors cannot discriminate the most harmful volatile organic compounds, such as formaldehyde and benzene, from less harmful volatile organic compounds. Therefore, embodiments of the present disclosure may overcome this disadvantage present in the prior art.

An aspect provides a system comprising: a first device for obtaining indications for studying transient behaviour of parameters of the environment within which the first device is located, the first device comprising: a pressure sensor configured to obtain an indication of pressure of the environment; a carbon dioxide sensor configured to obtain an indication of the amount of carbon dioxide in the environment; an ambient temperature sensor configured to obtain an indication of the ambient temperature of the environment; a relative humidity sensor configured to obtain an indication of the relative humidity of the environment; wherein each of the sensors comprises: a first mode wherein the sensor obtains absolute indications indicative of an absolute value of a parameter of the environment; and, a second mode wherein the sensor obtains indications indicative of changes in the parameter of the environment for a predetermined period of time; the device further comprising: a triggering sensor configured to obtain an indication of a change in a trigger parameter of the environment; wherein, in the event that the triggering sensor obtains an indication of a change in the trigger parameter of the environment above a predetermined threshold, the device triggers each of the pressure sensor, carbon dioxide sensor, ambient temperature sensor and relative humidity sensor to switch from the first mode to the second mode; and, a communication interface configured to send the indications to a computing device for studying transient behaviour of parameters of the environment; and, a second device for obtaining indications for studying transient behaviour of parameters of the environment within which the second device is located, the first device comprising the same components as the first device; and, a processor configured: to receive the indications from the first device and the second device; to determine, based on the indications, an indication of the transient behaviour of the parameters of the environment. Advantageously a system is provided for determining an indication of transient behaviour of parameters of the environment.

The devices may comprise a particulate matter sensor configured to obtain an indication of particulate matter in the environment, for example, the indication may be an indication of concentration of particles in the environment, and/or an indication of a distribution of particle size of particles in the environment.

The devices may comprise gas sensors (e.g. those described above, the nitrogen dioxide sensor etc.) configured to obtain an indication of an amount of a given gas in the environment. The indication may be an indication of a concentration of the given gas in the environment.

The processor may be configured to determine, based on the indications, at least one of: an indication of the thermal comfort of the environment; an indication of the air quality of the environment; an indication of the energy efficiency of the environment; an indication of air infiltration into the environment; an indication of performance of a mechanical ventilation system for ventilating the environment.

The indication of pressure from the first device may be modified to a modified indication of pressure based on at least one of: the indication of the amount of carbon dioxide from the first device; the indication of ambient temperature from the first device; an indication of an amount of gas from the first device; an indication of particle concentration and/or size distribution from the first device; and, the indication of relative humidity from the first device; and, the indication of pressure from the second device may be modified to a modified indication of pressure based on at least one of: the indication of the amount of carbon dioxide from the second device; the indication of ambient temperature from the second device; and, the indication of relative humidity from the second device.

The first device may comprise the processor; or, the second device may comprise the processor. Alternatively, the processor may be separate from the first device and second device. For example, the processor may be part of a cloud computer or a personal computer (e.g. a desktop, laptop, tablet or smartphone).

An aspect provides a method of operating a device for studying transient behaviour of parameters of an environment, the method comprising: obtaining indications of each of the parameters of the environment at a first sampling rate; in the event that a trigger parameter indicative of a start of transient behaviour exceeds a predetermined threshold, obtaining indications of each of the parameters of the environment at a second sampling rate for a predetermined period of time, wherein the second sampling rate is greater than the first sampling rate.

An aspect provides a system comprising: a first device comprising a first absolute pressure sensor configured to obtain a first indication of absolute pressure at a first location; and, a second device comprising an second absolute pressure sensor configured to obtain a second indication of absolute pressure at a second location, wherein the second location is spaced from the first location by a spacing; and, a processor configured to: obtain: the first indication of absolute pressure; and, the second indication of absolute pressure; and, an indication of the spacing; and, determine an airflow between the first device and second device based on the first indication of absolute pressure, the second indication of absolute pressure, and an indication of the spacing.

The first device may comprise at least one of: a carbon dioxide sensor configured to obtain an indication of the amount of carbon dioxide at the first location; a relative humidity sensor configured to obtain an indication of the relative humidity at the first location; an ambient temperature sensor configured to obtain an indication of the ambient temperature of the environment at the first location. The indication of absolute pressure at the first location may be modified based on at least one of: the indication of the amount of carbon dioxide at the first location; an indication of gas concentration of the environment at the first location; an indication of particle concentration and/or size distribution of the environment at the first location; the indication of the relative humidity at the first location; and, the indication of the ambient temperature of the environment at the first location. Likewise, the second device may comprise: a carbon dioxide sensor, a relative humidity sensor and an ambient temperature sensor; and the indication of absolute pressure at the second location may be modified on at least one of the indications obtained by these sensors.

An aspect provides a method of determining an air infiltration rate in an environment, the method comprising: obtaining an indication of the absolute pressure at: a first position in the environment; and, a second position in the environment wherein the second position is displaced from the first position by a spacing; obtaining an indication of the amount of carbon dioxide at: the first position; and, the second position; and the spacing; and, determining an air infiltration rate into the environment based on: the indication of the absolute pressure at the first position; the indication of the absolute pressure at the second position.

The methods described herein may be executed by a computing device or processor.

In examples, the devices described herein may comprise a means of obtaining an indication of the amount of people a room where the device is disposed, for example, the noise sensor may obtaining an indication of the activity level of occupants in a room based on the amount of noise in said room. Occupancy, occupant activity and volume and dimensions of the occupied space may be manually entered into the device or system. Using these parameters along with an indication of the amount of carbon dioxide in the room, an indication of the air change rate in the room can be determined, which is an indication of air quality. This is an improvement over prior art sensors which only use a carbon dioxide measurement to make an estimate of air quality.

Any combination of sensors described herein may be provided in a single device. Therefore, provided are devices and systems which can determine all of air quality, thermal comfort and ventilation system of an environment. Example devices provided herein may provide data (e.g. indications) which meet or exceed the data quality objectives (DQO) specified in the guidelines and standards.

Example devices provided herein may obtain data (e.g. indication) at time intervals that can record transient events because some analyses (e.g. for the study of transient behaviour of parameters of the environment) require knowledge of the rate of change of said parameters, rather than an equilibrium value (e.g. when the transient behaviour has passed and the parameters are in a steady state).

Systems provided herein comprise a plurality of devices which permit measurements (e.g. indications of parameters of the environment) to be obtained in multiple locations simultaneously for certain measurements which permits determination of an indication of air infiltration and/or mechanical ventilation system performance.

Using triggering sensors to switch operation mode of other sensors in the devices from a first mode to a second mode advantageously permits transient behaviours of parameters of the system to be obtained e.g. without excessive power drain by having the other sensors be in the second mode at all times (which is more power consumptive if operated continuously in the second mode).

Advantageously, data provided herein may be recorded for long periods (e.g. weeks, months or years, for example, given the energy efficiency of the device). This may provide improve data regarding air quality in comparison, for example, to IAQ walk-through audits which only take a snap-shot of the air quality, without observing diurnal, weekly or seasonal variations.

### BRIEF DESCRIPTION OF DRAWINGS

FIG. 1 illustrates a schematic view of a device for studying thermal comfort of an environment;

FIG. 2 illustrates a schematic view of a system for studying thermal comfort of an environment, wherein the system comprises a plurality of the devices illustrated in FIG. 1;

FIG. 3 illustrates a schematic view of a device for studying transient behaviour of parameters of an environment;

FIG. 4 illustrates a schematic view of a system for studying transient behaviour parameters of the environment, wherein the system comprises a plurality of the devices illustrated in FIG. 3;

FIG. 5 illustrates a schematic view of a device for studying thermal comfort of an environment, for studying transient behaviour of parameters of an environment, and for studying the quality of air in the environment;

FIG. 6 illustrates a schematic view of a device for studying thermal comfort of an environment, for studying transient behaviour of parameters of an environment, and for studying the quality of air in the environment.

In the drawings like reference numerals indicate like elements.

### SPECIFIC DESCRIPTION

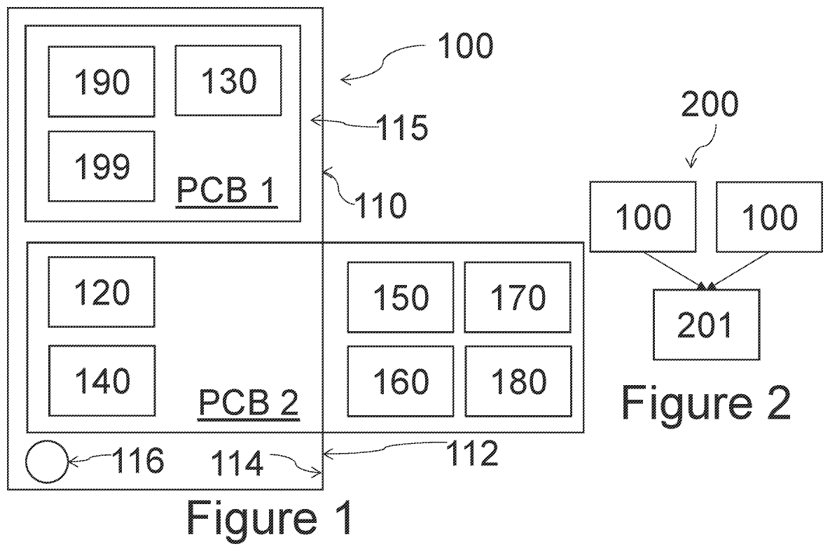

FIG. 1 illustrates a schematic view of a device 100 for studying thermal comfort of an environment which the device is located. The device 100 comprises: a housing 110; a pressure sensor 120; a carbon dioxide sensor 130; an ambient temperature sensor 140; a relative humidity sensor 150; a radiant temperature sensor 160; a first air speed sensor 170; a second air speed sensor 180; a power supply 190; and a communication interface 199.

FIG. 2 illustrates a schematic view of a system 200 for studying thermal comfort of the environment, wherein the system comprises a plurality of the devices 100 illustrated in FIG. 1. The system 200 comprises a plurality of the devices 100 and a computing device 201 configured to receive indications from the communication interfaces of the respective devices 100.

The sensors obtain indications of parameters of the environment within which the device 100 is disposed (e.g. the pressure sensor 120 obtains an indication of the pressure of the environment etc.). The communication interface 199 sends these indications to a computing device for determining an indication of the thermal comfort of the environment.

The computing device can be a processor which is part of the device 100 (e.g. the device comprises the computing device) or the computing device may be remote from the device 100. In examples wherein the computing device is remote from the device the computing device may be a cloud computer receiving the indications from the communication interface 199 via a network (comprising wired and/or wireless connections) or may be a personal computer receiving the indications from the communications interface 199 (e.g. wirelessly using, for example, a Bluetooth (RTM) connection or a local WiFi (RTM) network).

The computing device determines an indication of the thermal comfort of the environment based on the indications received from the communications interface 199. The indication of thermal comfort may be calculated according to the standards set out in ANSI/ASHRAE 55:2020 or ISO 7730.

The device 100 is described in more detail below, followed by a description of the system 200 comprising a plurality of devices 100.

The power supply 190 is connected to the pressure sensor 120, carbon dioxide sensor 130, ambient temperature sensor 140, relative humidity sensor 150, radiant temperature sensor 160, first air speed sensor 170, a second air speed sensor 180 and, communication interface 199. The power supply 190 provides power to each of the components it is connected thereto. The power supply 190 is a battery (e.g. comprising Lithium ion cells).

The housing 110 comprises an exterior surface 112 and an interior surface 114. The interior surface 114 encloses an interior 115 of the housing. The housing 110 comprises at least one aperture 116 configured to permit fluid communication between the environment and the interior 105 of the housing (e.g. the apertures allow air to flow in and flow out of the interior of the housing). Preferably the housing 110 is opaque to visible and infrared light.

The power supply 190 is configured to receive power from a mains power supply, for example, via a power connector such as a USB power connector (e.g. USB-B or USB-C). The power supply 190 is charged (e.g. the power it stores is increased) by the mains power supply. Advantageously, the power supply 190 prevents loss of power to the components connected thereto in the event that a mains power supply connection to the device is lost (e.g. during a power outage of the grid or by human intervention, such as a person disconnecting the device from the mains power supply).

The pressure sensor 120, carbon dioxide sensor 130, ambient temperature sensor 140, relative humidity sensor 150, radiant temperature sensor 160, first air speed sensor 170; and a second air speed sensor 180 are connected to the communication interface 199. The connections may comprise a conductive trace on printed circuit board, a wired connection, or a combination of the two.

The pressure sensor 120 is configured to obtain an indication of pressure of the environment e.g. an indication of air pressure in the environment. The pressure sensor 120 is configured to send the indication of the pressure of the environment to the communication interface 199.

The carbon dioxide sensor 130 is configured to obtain an indication of an amount carbon dioxide in the environment e.g. an indication the amount of carbon dioxide in the air in the environment, for example, an indication of the concentration of carbon dioxide in the air in the environment. The carbon dioxide sensor 130 is configured to send the indication of the amount of carbon dioxide in the environment to the communication interface 199.

The ambient temperature sensor 140 is configured to obtain an indication of ambient temperature of the environment e.g. an indication of the temperature of air in the environment. The ambient temperature sensor may be a temperature sensor configured to measure the temperature of air in the interior of the housing. The ambient temperature sensor 140 is configured to send the indication of the ambient temperature of the environment to the communication interface 199.

The relative humidity sensor 150 is configured to obtain an indication of relative humidity of the environment e.g. an indication of the relative humidity of water in the air in the environment. The relative humidity sensor 150 is configured to send the indication of the relative humidity of the environment to the communication interface 199.

The radiant temperature sensor 160 is configured to obtain an indication of radiant temperature of the environment e.g. an indication of the heat energy due to radiation (e.g. electromagnetic radiation) in the environment. The radiant temperature sensor 140 is configured to send the indication of the radiant temperature of the environment to the communication interface 199.

The first air speed sensor 170 is configured to obtain an indication of air speed in a first direction. The second air speed sensor 180 is configured to obtain an indication of air speed in a second direction. The first direction is perpendicular to the second direction. The first airspeed sensor 170 is configured to send the indication of the air speed in the first direction the communication interface 199. The second airspeed sensor 180 is configured to send the indication of the air speed in the second direction the communication interface 199. A second air speed sensor is shown, but it will be appreciated that a single air speed sensor (e.g. the first air speed sensor) may be provided alone.

In examples, the device 100 may comprise one of or any combination of: a nitrogen dioxide sensor configured to obtain an indication of an amount of nitrogen dioxide in the environment; a nitric oxide sensor configured to obtain an indication of an amount of nitric oxide in the environment; a hydrogen sulfide sensor configured to obtain an indication of an amount of hydrogen sulfide in the environment; a sulfur dioxide sensor configured to obtain an indication of an amount of sulfur dioxide in the environment; an ammonia sensor configured to obtain an indication of an amount of ammonia in the environment; a formaldehyde sensor configured to obtain an indication of an amount of formaldehyde in the environment; a benzene sensor configured to obtain an indication of an amount of benzene in the environment; an ozone sensor configured to obtain an indication of an amount of ozone in the environment; a carbon monoxide sensor configured to obtain an indication of an amount of carbon monoxide in the environment; a volatile organic compound sensor configured to obtain an indication of an amount of at least one volatile organic compound in the environment; and, a particulate matter sensor configured to obtain an indication of particulate matter in the environment. For example, each of these sensors may provide an indication the amount of that given chemical in the air in the environment, for example, an indication of the concentration of that given chemical in the air in the environment (e.g. in parts per million or any other appropriate indication of the amount of concentration of that given chemical). Any of the sensors described herein may a first mode and a second mode. The sensors provided herein may be connected to a multiplexer.

The power supply 190, communications interface 199, carbon dioxide sensor 130, pressure sensor 120, and the ambient temperature sensor 140 are disposed within the interior 115 of the housing 110. The relative humidity sensor 150, radiant temperature sensor 160, first air speed sensor 170, and second air speed sensor 180 are disposed outside of the housing 110.

Preferably, the ambient temperature sensor 140 is disposed away from the power supply 190 to prevent heat generated by the power supply 190 (e.g. due to charging or discharging of the power supply) raising the temperature of air disposed close to (e.g. in contact with) the ambient temperature sensor 140. The ambient temperature sensor 140 may be disposed on a different circuit board to the power supply 190.

A main PCB (PCB 1) is provided for holding the power supply 190, communications interface 199, and the carbon dioxide sensor 130 and a sensor PCB (PCB 2) is provided, separate from the main PCB, for holding the pressure sensor 120, ambient temperature sensor 140, relative humidity sensor 150, radiant temperature sensor 160, first air speed sensor 170, and a second air speed sensor 180.

A portion of the sensor PCB (PCB 2) may be disposed within the interior 115 of the housing 110 and another portion of sensor PCB (PCB 2) may be disposed outside of the housing 110. For example, a slot may be provided in the housing to permit the PCB to span between the interior 115 and the exterior of the housing 110. In this way, sensors which are disposed outside of the housing and within the interior of the housing may simply be mounted on the same sensor PCB.

The communications interface 199 is configured to send the indications to the computing device 201. The computing device 201 receives the indications from the device 100.

The computing device 201 comprises a processor configured to determine an indication of thermal comfort based on the received indications. The indication of thermal comfort may be calculated according to the standards set out in either ANSI/ASHRAE 55:2020 or ISO 7730.

As described above, the computing device can be a processor which is part of one of the devices 100 or the computing device may be remote from the device 100 (e.g. a cloud computer or a personal computer).

Typically a system 200 is provided comprising a plurality of each of the sensors 100. The computing device 201 may determine a plurality of indications of the thermal comfort of the environment wherein each indication of the thermal comfort is determined based on the indications from a given device. In such examples, the indications of thermal comfort provide an indication of thermal comfort at the location of each respective device. For example, if there are two devices, a first device in a first room and a second device in a second room, then a first indication of thermal may be determined based on the indications from the first device in the first room and a second indication of thermal comfort may be determined based on the indications from the second device in the second room; the first indication of thermal comfort may be indicative of the thermal comfort of the environment in the first room and the second indication of thermal comfort may be indicative of the thermal comfort of the environment in the second room.

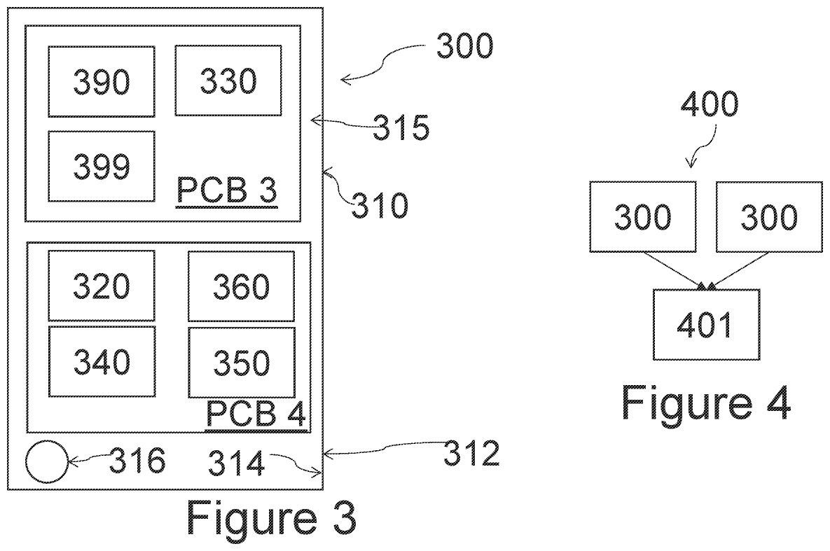

FIG. 3 illustrates a schematic view of a device 300 for studying transient behaviour of parameters of an environment within which the device is located. The device 300 comprises: a housing 310; a pressure sensor 320; a carbon dioxide sensor 330; an ambient temperature sensor 340; a relative humidity sensor 350; a triggering sensor 360; a power supply 390; and a communication interface 399.

FIG. 4 illustrates a schematic view of a system 400 for studying transient behaviour parameters of the environment, wherein the system comprises a plurality of the devices 300 illustrated in FIG. 3. The system 400 comprises a plurality of the devices 100 and a computing device 401 configured to receive indications from the communication interfaces of the respective devices 300.

The triggering sensor 350 is configured to obtain an indication in a trigger parameter of the environment. The trigger parameter is noise or light (or both). The other sensors (i.e. the sensors other than the triggering sensor 360, namely the pressure sensor 320, carbon dioxide sensor 330, and ambient temperature sensor 340) comprise a first mode and second mode. In the first mode, each of the other sensors obtains indications indicative of a parameter of the environment (e.g. the pressure sensor obtains an indication of absolute pressure etc.) at a first sampling rate; in the second mode, each of the other sensors obtains indications indicative of a parameter of the environment (e.g. the pressure sensor obtains an indication of absolute pressure etc.) at a second sampling rate, wherein the second sampling rate is greater than the first sampling rate.

In examples, in the first mode, each of the other sensors obtains indications indicative of an absolute value of the a parameter of the environment; in the second mode, each of the other sensors obtains indications indicative of changes in the parameter of the environment for a predetermined period of time.

In the event that the in the event that the triggering sensor obtains an indication of a change in the parameter of the environment above a predetermined threshold, the device triggers each of the one or more sensors to switch from the first mode to the second mode.

The other sensors obtain indications of parameters of the environment within which the device 300 is disposed (e.g. the pressure sensor 320 obtains an indication of the pressure of the environment etc.). The communication interface 399 sends these indications to a computing device for determining an indication of the thermal comfort of the environment.

The computing device can be a processor which is part of the device 300 (e.g. the device comprises the computing device) or the computing device may be remote from the device 300. In examples wherein the computing device is remote from the device the computing device may be a cloud computer receiving the indications from the communication interface 399 via a network (comprising wired and/or wireless connections) or may be a personal computer receiving the indications from the communications interface 399 (e.g. wirelessly using, for example, a Bluetooth (RTM) connection or a local WiFi (RTM) network).

The computing device determines an indication of the transient behaviour of the parameters of the environment within which the device 300 based on the indications received from the communications interface 199.

The device 300 is described in more detail below, followed by a description of the system 400 comprising a plurality of devices 300.

The housing 310 comprises an exterior surface 312 and an interior surface 314. The interior surface 314 encloses an interior 315 of the housing. The housing 310 comprises at least one aperture 316 configured to permit fluid communication between the environment and the interior 315 of the housing (e.g. the apertures allow air to flow in and flow out of the interior of the housing). Preferably the housing 310 is opaque to visible and infrared light.

The power supply 390 is connected to the pressure sensor 320, carbon dioxide sensor 330, ambient temperature sensor 340, relative humidity sensor 350, triggering sensor 360, and, communication interface 399. The power supply 390 provides power to each of the components it is connected thereto. The power supply 390 is a battery (e.g. comprising Lithium ion cells).

The power supply 390 is configured to receive power from a mains power supply, for example, via a power connector such as a USB power connector (e.g. USB-B or USB-C). The power supply 390 is charged (e.g. the power it stores is increased) by the mains power supply. Advantageously, the power supply 390 prevents loss of power to the components connected thereto in the event that a mains power supply connection to the device is lost (e.g. during a power outage of the grid or by human intervention, such as a person disconnecting the device from the mains power supply).

The pressure sensor 320, carbon dioxide sensor 330, ambient temperature sensor 340, relative humidity sensor 350, are connected to the communication interface 399. The triggering sensor 350 may also be connected to the communication interface 399 and the communication interface 399 may send indications of the triggering sensor The connections may comprise a conductive trace on printed circuit board, a wired connection, or a combination of the two.

The pressure sensor 320 is configured to obtain an indication of pressure of the environment e.g. an indication of air pressure in the environment. The pressure sensor 320 is configured to send the indication of the pressure of the environment to the communication interface 399.

The carbon dioxide sensor 330 is configured to obtain an indication of an amount carbon dioxide in the environment e.g. an indication the amount of carbon dioxide in the air in the environment, for example, an indication of the concentration of carbon dioxide in the air in the environment. The carbon dioxide sensor 330 is configured to send the indication of the amount of carbon dioxide in the environment to the communication interface 399.

The ambient temperature sensor 340 is configured to obtain an indication of ambient temperature of the environment e.g. an indication of the temperature of air in the environment. The ambient temperature sensor may be a temperature sensor configured to measure the temperature of air in the interior of the housing. The ambient temperature sensor 340 is configured to send the indication of the ambient temperature of the environment to the communication interface 399.

The relative humidity sensor 350 is configured to obtain an indication of relative humidity of the environment e.g. an indication of the relative humidity of water in the air in the environment. The relative humidity sensor 350 is configured to send the indication of the relative humidity of the environment to the communication interface 399.

In examples, the devices 300 may comprise one of or any combination of: a nitrogen dioxide sensor configured to obtain an indication of an amount of nitrogen dioxide in the environment; a nitric oxide sensor configured to obtain an indication of an amount of nitric oxide in the environment; a hydrogen sulfide sensor configured to obtain an indication of an amount of hydrogen sulfide in the environment; a sulfur dioxide sensor configured to obtain an indication of an amount of sulfur dioxide in the environment; an ammonia sensor configured to obtain an indication of an amount of ammonia in the environment; a formaldehyde sensor configured to obtain an indication of an amount of formaldehyde in the environment; a benzene sensor configured to obtain an indication of an amount of benzene in the environment; an ozone sensor configured to obtain an indication of an amount of ozone in the environment; a carbon monoxide sensor configured to obtain an indication of an amount of carbon monoxide in the environment; a volatile organic compound sensor configured to obtain an indication of an amount of at least one volatile organic compound in the environment; and, a particulate matter sensor configured to obtain an indication of particulate matter in the environment. For example, each of these sensors may provide an indication the amount of that given chemical in the air in the environment, for example, an indication of the concentration of that given chemical in the air in the environment (e.g. in parts per million or any other appropriate indication of the amount of concentration of that given chemical). Any of the sensors described herein may a first mode and a second mode. The sensors provided herein may be connected to a multiplexer.

The triggering sensor 360 is configured to obtain a change in a trigger parameter of the environment. In the present example, the triggering sensor is a light sensor. The light sensor 360 is configured to obtain an indication of light incident on the light sensor 360. In the event the indication indicates an amount of light incident on the light sensor 360 is above a predetermined light threshold the device 300 triggers the other sensors (i.e. sensors 320, 330, 340 and 350) to switch from the first mode to the second mode for a predetermined mode.

The light sensor may be replaced with a noise sensor. The noise sensor is configured to obtain an indication of noise in the environment. In the event the indication indicates an amount of noise in the environment is above a predetermined noise threshold the device triggers the other sensors (i.e. sensors 320, 330 340 and 350) to switch from the first mode to the second mode for a predetermined period of time.

Two triggering sensors may be provided, for example, a light sensor and a noise sensor.

In examples wherein two triggering sensors are provided the other sensors may be switched from the first mode to the second mode in the event that both the light sensor obtains an indication which indicates an amount of light incident on the light sensor is above a predetermined light threshold and noise sensor obtains an indication which indicates an amount of noise in the environment is above a predetermined noise threshold. Advantageously false triggering events (e.g. events which would not produce transient changes in parameters of environment which are the object of study) may be avoided which may reduce the need to remove the obtained indications from an obtained dataset and/or may reduce the power consumption of the sensors and communications interface on the battery.

In examples wherein two triggering sensors are provided the other sensors may be switched from the first mode to the second mode in the event that at least one of the light sensor obtains an indication which indicates an amount of light incident on the light sensor is above a predetermined light threshold and/or the noise sensor obtains an indication which indicates an amount of noise in the environment is above a predetermined noise threshold. Advantageously more triggering events may occur (i.e. in comparison to examples wherein both the light and noise must exceed a threshold) and so indications of a comparatively greater number of transient events may be obtained for study. Advantageously if one of the triggering sensors fails then then indications of transient behaviour may be obtained.

The pressure sensor 320, carbon dioxide sensor 330, ambient temperature sensor 340 the relative humidity sensor 350, power supply 390 and communications interface 399 are disposed within the interior 305 of the housing. In examples wherein the triggering sensor 360 is a noise sensor it is disposed either within the interior 315 of the housing 310 or outside of the housing. In examples wherein the triggering sensor 360 is a light sensor it is disposed either within the interior 315 of the housing or outside of the housing.

Preferably, the ambient temperature sensor 340 is disposed away from the power supply 390 to prevent heat generated by the power supply 390 (e.g. due to charging or discharging of the power supply) raising the temperature of air disposed close to (e.g. in contact with) the ambient temperature sensor 340. The ambient temperature sensor 340 may be disposed on a different circuit board to the power supply 390.

A main PCB (PCB 3) is provided for holding the power supply 390, communications interface 399, and the carbon dioxide sensor 330 and a sensor PCB (PCB 4) is provided, separate from the main PCB, for holding the pressure sensor 320, ambient temperature sensor 340, relative humidity sensor 350, and trigger sensor 360.

A portion of the sensor PCB (PCB 4) may be disposed within the interior 315 of the housing 310 and another portion of sensor PCB (PCB 4) may be disposed outside of the housing 310. For example, a slot may be provided in the housing to permit the PCB to span between the interior 315 and the exterior of the housing 310. In this way, sensors which are disposed outside of the housing and within the interior of the housing may simply be mounted on the same sensor PCB.

The communications interface 399 is configured to send the indications to the computing device 401. The computing device 401 receives the indications from the device 300. The computing device 401 stores the received indications (e.g. as a dataset) to permit the environment to be studied. Advantageously transient phenomena can be studied using the device 300 because the sensor is able to operate in a first mode and a second mode. The device 300 is configured to reduce power consumption of the sensors by only switching to the second mode (e.g. a more power consumptive mode because the sampling rate of the sensors in the second mode is greater than in the first mode).

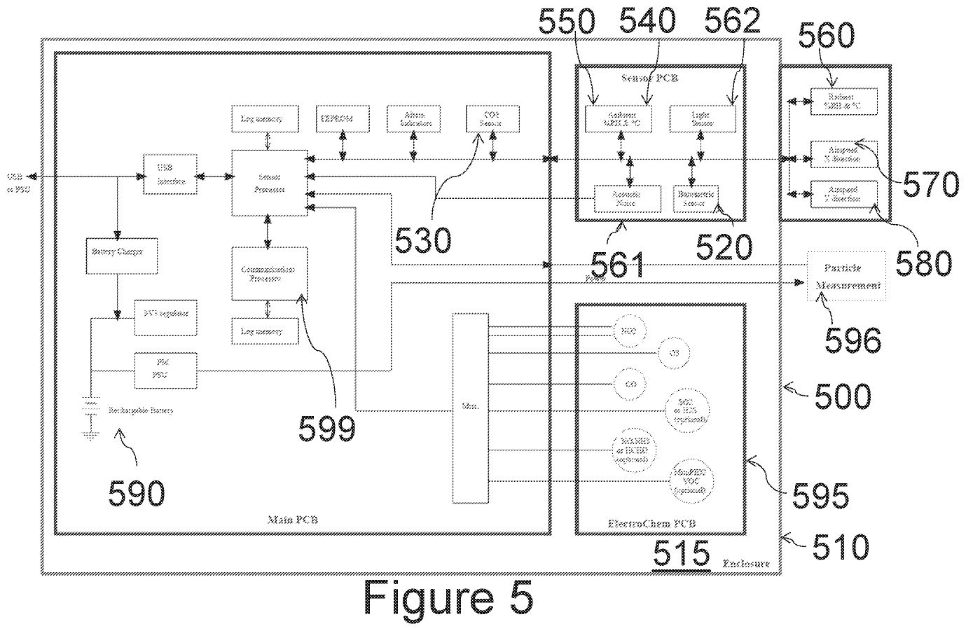

FIG. 5 illustrates a schematic view of a device 500 for studying thermal comfort of an environment, for studying transient behaviour of parameters of an environment, and for studying the quality of air in the environment.

The device 500 comprises: a housing 510 comprising an interior 515; a pressure sensor 520 configured to obtain an indication of pressure of the environment; a carbon dioxide sensor 530 configured to obtain an indication of an amount carbon dioxide in the environment; an ambient temperature sensor 540 configured to obtain an indication of ambient temperature of the environment; a relative humidity sensor 550 configured to obtain an indication of relative humidity of the environment; a radiant temperature sensor 560 configured to obtain an indication of radiant temperature of the environment; a first triggering sensor 561 consisting of a noise sensor configured to obtain an indication of noise in the environment; a second triggering sensor 562 consisting of a light sensor configured to obtain an indication of light incident on the sensor; a first air speed sensor 570 configured to obtain an indication of air speed in a first direction; a second air speed sensor 580 configured to obtain an indication of air speed in a second direction; an electrochemical sensor 595 configured to obtain a plurality of indications wherein each indication is indicative of an amount of a chemical in the environment; a particle measurement sensor 596 configured to obtain indications indicative of particles in the environment; a communication interface 599 configured to send indications obtained by the sensors to a computing device.

The device 500 can be operated in the same manner as the device 100 illustrated in FIG. 1 i.e. the device 500 can be operated for studying thermal comfort of an environment. In other words device 500 comprises all of the technical features of device 100. Moreover, a system may be provided comprising a computing device and a plurality of devices 500 wherein the system is operated for studying thermal comfort of the environment.

The device 500 can be operated in the same manner as the device 300 illustrated in FIG. 1 i.e. the device 500 can be operated for studying transient behaviour of parameters of an environment. In other words device 500 comprises all of the technical features of device 300. Moreover, a system may be provided comprising a computing device and a plurality of devices 500 wherein the system is operated for studying transient behaviour of parameters of an environment.

The device 500 is operable in the manner of device 100 and device 300 simultaneously. For example, the device 500 obtains indications from the respective sensors operated in a first mode (e.g. the pressure sensor 500 an indication of the pressure of the environment etc.). These indications are sent to the computing device by the communication interface 599 for determination of an indication of thermal comfort of the environment. The device 500 also comprises two triggering sensors (i.e. the first triggering sensor 561 and the second triggering sensor 562). In the event that either of the indication from either triggering sensor exceeds a predetermined threshold, the device 500 switches the sensors to the second mode (e.g. the sensors are operated in the second mode instead of the first mode). The indications obtained by the sensors in the second mode are sent to a computing device by the communications interface 599 for the study of transient behaviour of parameters of the environment.

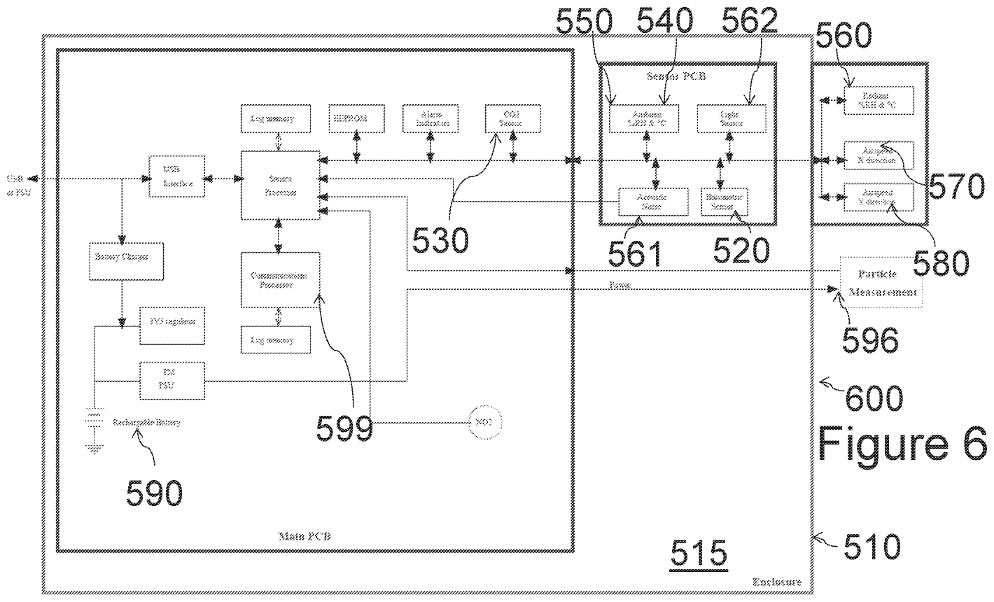

FIG. 6 illustrates a schematic view of a device 600.

The device 600 comprises all of the features of device 500 except device 600 omits the electrochemical sensor 595.

Devices and systems described herein may be configured to determine an indication of air quality, for example, an Air Quality Index (AQI). The AQI is determined based on an indication of at least one of carbon dioxide, PM2.5, PM10 (both defined below), and, nitrogen dioxide. AQI is a very common index for air quality; the specific form of the equation varies jurisdictions, for example, in the UK the equation is termed the Daily Air Quality Index. It is rated 1-10, based on the highest concentration of NO2, O3, SO2, PM2.5 and PM10.

Devices and systems described herein may be configured to determine an indication of Heat Index. The Heat Index is determined based on indications of: relative humidity, local airspeed, ambient temperature and radiant temperature ;. The Heat Index is an example of an indication of thermal comfort of the environment.

Devices and systems described herein may be configured to determine an indication of Wet Bulb Globe Temperature (WGBT). The WBGT is determined based on indications of: radiant temperature, airflow, relative humidity and ambient temperature. The WBGT is an example of an indication of thermal comfort of the environment.

Particles (i.e. particulate matter) less than 10 micrometres in diameter are referred to as PM10. Particles (i.e. particulate matter) less than 2.5 micrometres in diameter are referred to as PM2.5.

Pressure sensors provided in the devices described herein may be absolute pressure sensors. Advantageously, using an absolute pressure sensor may provide more accurate indications of pressure (e.g. air pressure) in the environment across many adjacent spaces in comparison to differential pressure sensors. Alternatively the pressure sensors may be differential pressure sensors which advantageously may be cheaper to provide or easier to use (less calibration required) than absolute pressure sensors.

Instead of the first direction being perpendicular to the second direction, the first direction may be oblique to the second direction.

Ambient temperature may refer to an indication of average kinetic energy of molecules in a gas (e.g. air). Radiant temperature may refer to an indication of the increased ambient temperature due to the inclusion of thermal radiation in the environment.

Indications of: the air quality of the environment; may be found in the World Health Organisation WHO Guidelines for Indoor Air: 2010.

The systems described herein comprise two devices, but it will be readily appreciated by those skilled in the art that any further number of devices may be added to the system.

An indication of performance of a mechanical ventilation system for ventilating the environment (e.g. the energy efficiency of the mechanical ventilation system). For example, the indication may be based on any of: the air infiltration into the environment; the energy efficiency of the environment; and an indication of the operational conditions of the mechanical ventilation system (e.g. its power, the volume of air it can move per unit time, its heat output (either into the environment or out of the environment). CO2 concentration can be used to calculate the air mixing ratio (fresh air: recycled air) and air change rate, providing the volume of fresh air as L/s. Likewise, differences of temperature and relative humidity between outside and indoor can be used to calculate the output energy, to compare with the measured electrical power.

Infiltration or air infiltration refers to air flow in or out of the environment (e.g. an indoor space, such as a building or room in a building) that is not controlled by a mechanical ventilation system for providing air to the environment. By determining an indication of air infiltration (or of the energy efficiency of the environment), a mechanical ventilation system (e.g. a building management system (BMS)) may be controlled (e.g. by one of the devices or computing devices described herein, or alternatively by a user based on the determined indication of the air infiltration) to provide air via the mechanical ventilation system of an appropriate temperature and/or volume and/or at specific times to improve or optimise energy efficiency of the environment (i.e. reduce energy loss from the environment) and/or to improve or optimise energy efficiency of the mechanical ventilation system.

The device or computing device described herein may operate a mechanical ventilation system based on a determined indication of air quality of the environment. For example, if the air quality is deemed unfavourable for a human inhabitant of the environment (e.g. levels of chemicals in the air above a predetermined level, for example, carbon dioxide above a given amount) then the mechanical ventilation system may be operated to direct fresh air, diluting the chemical in the environment, to thereby reduce the amount of the chemical in the environment.

Devices described herein may comprise a memory for storing indications. In some examples, the stored indications may be associated with a time at which the indications were obtained. In such examples, the communications interface may only send the indications to the computing device at predetermined time intervals (e.g. once a day) or when prompted by a user (e.g. when a user connects the device to the computing device). Advantageously, the power consumption of the communications interface on the power supply may be reduced and the battery life may therefore be extended.

Provided is a first device disposed in a first location comprising an absolute pressure sensor and a second device disposed in a second location comprising an absolute pressure sensor. A pressure difference between the first location and second location may be determined by determining the difference between the indicated absolute pressure at the first location (using the absolute pressure sensor of the first device) and the indicated absolute pressure at the second location (using the absolute pressure sensor of the second device). This may provide a more accurate determination of the pressure difference between the two locations than if the devices comprised differential pressure sensors.

Other examples and variations of the disclosure will be apparent to the skilled addressee in the context of the present disclosure.

The term computing device refers to a device comprising a processor configured to perform logical operations based on indications received from the communication interface of the device.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Any processors used in the computing device (and any of the activities and apparatus outlined herein) may be implemented with fixed logic such as assemblies of logic gates or programmable logic such as software and/or computer program instructions executed by a processor. The computing device may comprise a central processing unit (CPU) and associated memory, connected to a graphics processing unit (GPU) and its associated memory. Other kinds of programmable logic include programmable processors, programmable digital logic (e.g., a field programmable gate array (FPGA), a tensor processing unit (TPU), an erasable programmable read only memory (EPROM), an electrically erasable programmable read only memory (EEPROM), an application specific integrated circuit (ASIC), or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the computing device (and any of the apparatus outlined herein).

1. A device for obtaining indications for the study of thermal comfort of an environment within which the device is located, the device comprising:
a pressure sensor configured to obtain an indication of pressure of the environment;
a carbon dioxide sensor configured to obtain an indication of the amount of carbon dioxide in the environment;
an ambient temperature sensor configured to obtain an indication of the ambient temperature of the environment;
a relative humidity sensor configured to obtain an indication of the relative humidity of the environment;
a radiant temperature sensor configured to obtain an indication of the radiant temperature in the environment;
a first airspeed sensor configured to obtain an indication of air speed in a first direction; and,
a communication interface configured to send the indications to a computing device for determining an indication of the thermal comfort of the environment.

2. The device of claim 1, comprising:
a housing having:
an exterior surface;
an interior surface inclosing an interior of the housing; and,
at least one aperture configured to permit fluid communication between the environment and the interior of the housing;
wherein at least the ambient temperature sensor is disposed within the interior of the housing.

3. The device of claim 1, wherein:
each of the sensors comprises:
a first mode wherein the sensor obtains absolute indications indicative of an absolute value of a parameter of the environment; and,
a second mode wherein the sensor obtains indications indicative of changes in the parameter of the environment for a predetermined period of time;
the device further comprising:
a triggering sensor configured to obtain an indication of a change in a trigger parameter of the environment; wherein, in the event that the triggering sensor obtains an indication of a change in the trigger parameter of the environment above a predetermined threshold, the device triggers each of the other sensors, to switch from the first mode to the second mode.

4. The device of claim 3, wherein:
the triggering sensor is a light sensor, wherein the light sensor is disposed at an exterior of the housing, wherein the light sensor is configured to obtain an indication of light incident on the light sensor, wherein in the event the indication indicates an amount of light incident on the light sensor is above a predetermined light threshold the device triggers the other sensors to switch from the first mode to the second mode.

5. The device of claim 4, wherein:
the triggering sensor is a noise sensor, wherein the noise sensor is configured to obtain an indication of noise in the environment, wherein in the event the indication indicates an amount of noise in the environment is above a predetermined noise threshold the device triggers the other sensors to switch from the first mode to the second mode.

6. The device of claim 1, comprising:
a radiant temperature sensor disposed at an exterior of the housing, wherein the radiant temperature sensor is configured to obtain an indication of the radiant temperature in the environment.

7. A system comprising:
a first device according to claim 1;
a second device according to claims 1;
a processor configured:
to receive the indications from the first device and the second device;
to determine, based on the indications, an indication of the thermal comfort of the environment.

8. The system of claim 7, wherein:
the processor is configured to determine, based on the indications, at least one of:
an indication of the air quality of the environment;
an indication of the energy efficiency of the environment;
an indication of air infiltration into the environment;
an indication of performance of a mechanical ventilation system for ventilating the environment.

9. The system of claim 7, wherein:
the indication of pressure from the first device is modified to a modified indication of pressure based on at least one of: the indication of the amount of carbon dioxide from the first device; the indication of ambient temperature from the first device; and, the indication of relative humidity from the first device; and,
the indication of pressure from the second device is modified to a modified indication of pressure based on at least one of: the indication of the amount of carbon dioxide from the second device; the indication of ambient temperature from the second device; and, the indication of relative humidity from the second device.

10. A method for determining an indication of thermal comfort of an environment using a device of claim 1, the method comprising:
obtaining an indication of pressure of the environment using the device;
obtaining an indication of the amount of carbon dioxide in the environment using the device;
obtaining an indication of the ambient temperature of the environment using the device;
obtaining an indication of the relative humidity of the environment using the device;
obtaining an indication of the radiant temperature in the environment using the device;
obtaining an indication of air speed in a first direction using the device; and,
obtaining an indication of air speed in a second direction using the device, wherein the second direction is oblique or perpendicular to the first direction;
determining the indication of thermal comfort of the environment based on the indications.

11. A device for obtaining indications for studying transient behaviour of parameters of the environment within which the device is located, the device comprising:
a pressure sensor configured to obtain an indication of pressure of the environment;
a carbon dioxide sensor configured to obtain an indication of the amount of carbon dioxide in the environment;
an ambient temperature sensor configured to obtain an indication of the ambient temperature of the environment;
a relative humidity sensor configured to obtain an indication of the relative humidity of the environment;
wherein each of the sensors comprises:
a first mode wherein the sensor obtains absolute indications indicative of an absolute value of a parameter of the environment; and,
a second mode wherein the sensor obtains indications indicative of changes in the parameter of the environment for a predetermined period of time;
the device further comprising:
a triggering sensor configured to obtain an indication of a change in a trigger parameter of the environment; wherein, in the event that the triggering sensor obtains an indication of a change in the trigger parameter of the environment above a predetermined threshold, the device triggers each of the pressure sensor, carbon dioxide sensor, ambient temperature sensor and relative humidity sensor to switch from the first mode to the second mode; and,
a communication interface configured to send the indications to a computing device for studying transient behaviour of parameters of the environment.

12. The device of claim 11, wherein:
the triggering sensor is a light sensor, wherein the light sensor is disposed at an interior of the housing, wherein the housing comprises an aperture to permit light to enter the interior of the housing, wherein the light sensor is configured to obtain an indication of light incident on the light sensor, wherein in the event the indication indicates an amount of light incident on the light sensor is above a predetermined light threshold the device triggers the other sensors to switch from the first mode to the second mode.

13. The device of claim 11, wherein:
the triggering sensor is a noise sensor, wherein the noise sensor is configured to obtain an indication of noise in the environment, wherein in the event the indication indicates an amount of noise in the environment is above a predetermined noise threshold the device triggers the other sensors to switch from the first mode to the second mode.

14. The device of claim 11, comprising:
a radiant temperature sensor configured to obtain an indication of the radiant temperature in the environment;
a first airspeed sensor configured to obtain an indication of air speed in a first direction; and,
a second airspeed sensor configured to obtain an indication of air speed in a second direction, wherein the second direction is oblique or perpendicular to the first direction;
a communication interface configured to send the indications to a computing device for determining an indication of the thermal comfort of the environment.

15. The device of claim 14, wherein:
at least of the sensors of claim 17 comprises a first mode and a second mode.

16. A system comprising:
a first device according to claim 15;
a second device according to claim 15;
a processor configured:
to receive the indications from the first device and the second device;
to determine, based on the indications, an indication of the transient behaviour of the parameters of the environment.

17. The system of claim 16, wherein:
the processor is configured to determine, based on the indications, at least one of:
an indication of the thermal comfort of the environment;
an indication of the air quality of the environment;
an indication of the energy efficiency of the environment;
an indication of air infiltration into the environment;
an indication of performance of a mechanical ventilation system for ventilating the environment.

18. The system of claim 16, wherein:
the indication of pressure from the first device is modified to a modified indication of pressure based on at least one of: the indication of the amount of carbon dioxide from the first device; the indication of ambient temperature from the first device; and, the indication of relative humidity from the first device; and,
the indication of pressure from the second device is modified to a modified indication of pressure based on at least one of: the indication of the amount of carbon dioxide from the second device; the indication of ambient temperature from the second device; and, the indication of relative humidity from the second device.

19. The system of claim 16, wherein:
either: the first device comprises the processor; or, the second device comprises the processor.

20. A method of operating a device for studying transient behaviour of parameters of an environment, the method comprising:
obtaining indications of each of the parameters of the environment at a first sampling rate;
in the event that a trigger parameter indicative of a start of transient behaviour exceeds a predetermined threshold, obtaining indications of each of the parameters of the environment at a second sampling rate for a predetermined period of time, wherein the second sampling rate is greater than the first sampling rate.
